(19) United States
(12) Patent Application Publication
(10) Pub. No.: US 2016/0098768 A1
(43) Pub. Date: Apr. 7, 2016

(54) MEASURING AND ASSESSING POWER GENERATED BY A RENEWABLE POWER SYSTEM

(71) Applicant: SolarCity Corporation, San Mateo, CA (US)

(72) Inventors: Leland Price, San Francisco, CA (US); Chet McGensy, San Francisco, CA (US)

(73) Assignee: SolarCity Corporation

(21) Appl. No.: 14/805,429

(22) Filed: Jul. 21, 2015

Related U.S. Application Data
(60) Provisional application No. 62/061,113, filed on Oct. 7, 2014.

(51) Int. Cl. G06Q 30/02; G06Q 50/06

(52) U.S. Cl. CPC G06Q 30/0283; G06Q 50/06

(57) ABSTRACT

Systems and methods are provided for using a power measuring component to monitor a renewable power system and measure actual power generated, and assessing the actual power generated and/or the renewable power system itself based in part on the measured actual power and a total expected power output.

### CROSS-REFERENCES TO RELATED APPLICATIONS

This patent application claims the benefit of U.S. Provisional Application No. 62/061,113, filed Oct. 7, 2014, which is incorporated by reference herein.

### FIELD

This relates to methods and apparatus for using a power measuring component to monitor a renewable power system and measure actual power generated, and assessing the actual power generated and/or the renewable power system itself based in part on the measured actual power and a total expected power output.

### BACKGROUND

Resources like coal, oil, and natural gas are not renewable, the known reserves are being consumed rapidly, and burning them and transporting them is a major cause of pollution and environmental damage. So, many people in general, and governments in particular, are looking for ways to get renewable energy systems launched and into mainstream use, both for profit, and for the environment we all share.

Market revenues for solar, wind, biofuels and fuel cell clean technologies were $55 billion in 2006 and are expected to grow to $226 billion by 2016, according to industry research firm Clean Edge (March 2007). The federal government, utility providers, and city, state, and local agencies are offering incentives to make renewable energy more affordable for consumers. As a result, the investment market in the United States for energy efficiency is estimated to be $200 billion, according to the American Council for an Energy Efficient Economy.

Photovoltaic (PV) solar systems cleanly and silently convert sunlight into electrical energy. System integrators can install solar panel arrays at the point of consumption, e.g., on a customer's roof, to avoid transmission losses and costs. In addition, the electricity produced may be sold to the utility grid.

When exposed to strong light, the semiconductor devices in the panels produce low-voltage direct current (DC) electrical power, which an inverter converts to normal 110/220 volt utility-type alternating current (AC). The amount of energy produced by a single installation can be a substantial percentage of, or exceed, that used by a typical household.

### BRIEF SUMMARY

In some embodiments, systems and methods are provided for using a power measuring component to monitor a renewable power system and measure actual power generated, and assessing the actual power generated and/or the renewable power system itself based in part on the measured actual power generated and a total expected power output.

In some embodiments, a solar power system is provided that comprises: a photovoltaic solar panel configured to generate direct current (DC)-based power (DC power); an inverter coupled to the photovoltaic solar panel for converting the DC power into alternating current (AC)-based power (AC power); a power meter coupled to the inverter for measuring an amount of actual AC power generated by the solar power system; a gateway communicatively coupled to the power meter for receiving power data corresponding to the measured actual amount of AC power generated by the solar power system; and a server communicatively coupled to the gateway. In some embodiments, the server is configured to: receive, from the gateway, the power data corresponding to the measured actual amount of AC power generated by the solar power system; assess a value of the measured actual amount of AC power generated by the solar power system based at least in part on the product of an equivalent power rate and the measured actual amount of AC power generated by the solar power system; and calculate a payment amount based at least in part on the value of the measured actual amount of AC power generated by the solar power system and a total acquisition amount of at least a portion of the solar power system.

In some embodiments, the equivalent power rate is based at least in part on a total expected power output of the solar power system and the total acquisition amount. In some embodiments, the total expected power output of the solar power system is determined based at least in part on a location, a rating of the solar panel, a rating of the inverter, shading information, and tilt information. In some embodiments, the photovoltaic solar panel, the inverter, the power meter, and the gateway are installed at a home of a user. In some embodiments, the payment amount is an installment payment amount based at least in part on the total acquisition amount. In some embodiments, the payment amount is an installment payment amount based at least in part on an acquisition period, wherein the acquisition period is a plurality of months and the installment payment amount is for one of the plurality of months within the acquisition period.

In some embodiments, a method is provided that comprises the steps of: monitoring, by a server, an amount of actual power generated by a power system by obtaining power data from a gateway that is communicatively coupled to a power measuring component of the power system, wherein the power data corresponds to the amount of actual power generated by the power system; obtaining, by the server, an equivalent power rate for power generated by the power system, wherein the equivalent power rate is based at least in part on a total acquisition amount of a least a portion of the power system and a total expected power output of the power system; assessing, by the server, a value of the amount of actual power generated by the power system based at least in part on the product of the equivalent power rate and the amount of actual power generated by the power system; and calculating, by the server, an installment amount based at least in part on the value of the amount of actual power generated by the power system, the total acquisition amount of the power system, and an acquisition period.

In some embodiments, the acquisition period is a plurality of months and the installment payment amount is for one of the plurality of months within the acquisition period. In some embodiments, the power system is a solar power system that includes a solar panel. In some embodiments, the power measuring component is an inverter, which is configured to convert power generated by the solar panel from DC power to AC power. In some embodiments, the inverter is further configured to measure the actual amount of power produced by the power system. In some embodiments, the total expected power output of the power system is determined based at least in part on a location, a rating of the solar panel, a rating of the inverter, shading information, and tilt information. In some embodiments, the gateway and the power system are installed at a home of the user and the gateway transmits to the server information related to the power generation of the power system. In some embodiments, the method further comprises the step of increasing the equivalent power rate during the acquisition period to account for depreciating production of the power system. In some embodiments, an expected useful life of the power system is greater than the acquisition period. In some embodiments, the power system is a solar power system, a wind power system, a fossil-fuel based power system, a hydropower system, a nuclear power system, a biofuel power system, or a battery power system.

In some embodiments, a method is provided that comprises the steps of: monitoring, by a server, an amount of actual power generated by a solar power system by obtaining power data from a gateway that is communicatively coupled to a power measuring component of the solar power system, wherein the power data corresponds to the amount of actual power generated by the solar power system; obtaining, by the server, an equivalent kWh rate for power generated by the solar power system, wherein the equivalent kWh rate is based at least in part on a total acquisition amount of at least a portion of the solar power system and a total expected power output of the solar power system, wherein the total expected power output of the solar power system is the total expected power output during a term of a loan; assessing, by the server, a value of the amount of actual power generated by the solar power system based at least in part on the product of the equivalent kWh rate and the amount of actual power generated by the solar power system; and calculating, by the server, a payment amount based on the value of the amount of actual power generated by the solar power system and the total acquisition amount. In some embodiments, the total expected power output of the solar power system is determined based at least in part on a location, a rating of the solar panel, a rating of the inverter, shading information, and tilt information.

### BRIEF DESCRIPTION OF THE DRAWINGS

FIG. 1 shows a block diagram of an example environment for implementing aspects of embodiments disclosed herein.

FIG. 2 shows a block diagram depicting aspects of an example gateway, according to an embodiment.

FIG. 3 shows a block diagram depicting aspects of an example system, according to an embodiment.

FIG. 4 shows an example process for measuring an amount of power generated by a renewable power system, according to an embodiment

FIG. 5 shows example process 500 for assessing power generated by a renewable power system based at least in part on an acquisition amount of a renewable power system, according to an embodiment.

FIG. 6 shows an example process for determining a total acquisition amount of a renewable power system, according to an embodiment.

FIG. 7 shows an example process for determining a total amount of power expected to be generated by a renewable power system, according to an embodiment.

FIG. 8 shows an example valuation table of variable payment amounts, according to an embodiment.

FIG. 9 shows example process of processing an installment amount paid toward the costs of acquiring a renewable power system, according to an embodiment.

FIG. 10 shows an example environment in which embodiments may be implemented, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details, and that variations and other aspects not explicitly disclosed herein are contemplated within the scope of the various embodiments. Furthermore, well-known features may be omitted or simplified in order not to obscure the embodiment being described.

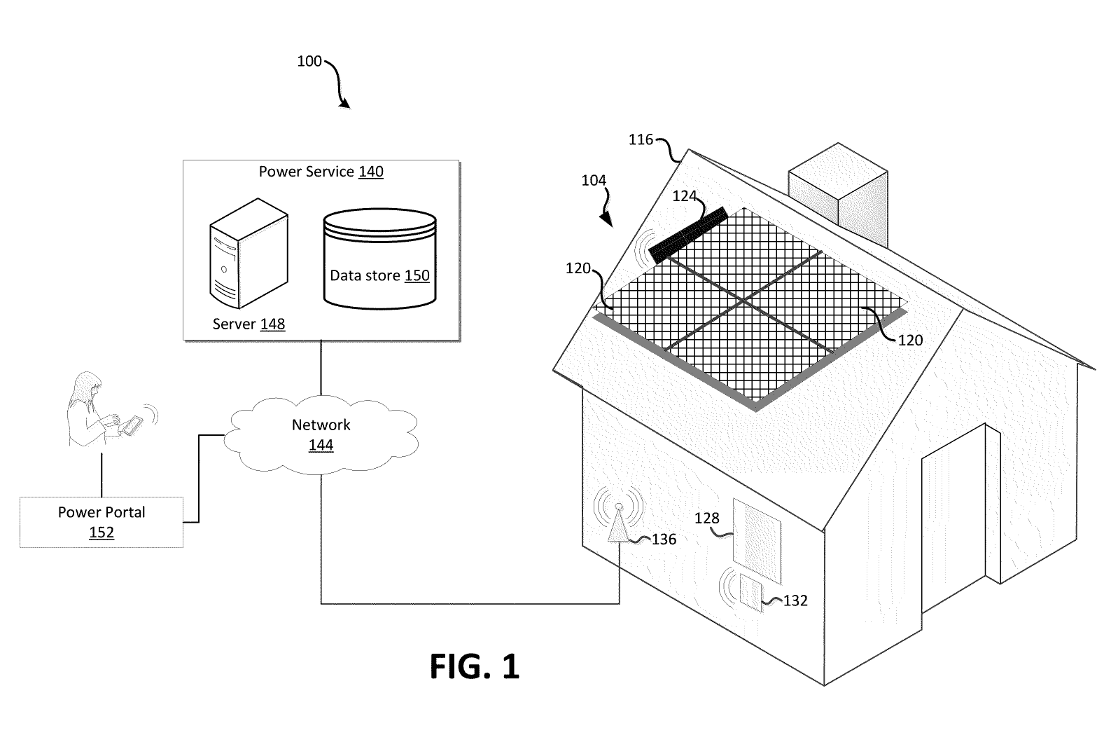

FIG. 1 shows an example of environment 100 for implementing aspects in accordance with various embodiments. As will be appreciated, although environment 100 is provided for purposes of explanation, different environments may be utilized, as appropriate, to implement various embodiments.

In some embodiments, environment 100 can include solar power system 104 located at user's home 116. Solar power system 104 can include photovoltaic solar panels 120 and inverter 124. Solar panels 120 convert sunlight into low-voltage direct current (DC), which is sometimes referred to as DC power or DC-based power. Inverter 124 converts the low-voltage DC into higher-voltage alternating current (AC), which is sometimes referred to as AC power or AC-based power. Examples of AC power measurement values include 110 VAC, 220 VAC, or 480 VAC. In some embodiments, solar power system 104 includes one or more power meters for measure DC power from photovoltaic solar panels and/or AC power from inverter 124. In some embodiments, the one or more power meters are coupled to inverter 124 and/or photovoltaic solar panels 120. For example, the one or more power meters can be a separate and/or a built-in component of inverter 124 and/or photovoltaic solar panels 120.

In some embodiments, environment 100 further includes an electric panel, or breaker box 128, which includes fuses and circuit breakers that distribute electricity to the user's electrical loads. Net-metering can be performed by selling excess electrical power from inverter 124 to a utility, which may be under contract or other legal obligation to accept and pay for such excess power. For example, inverter 124 or another component can push excess electrical power generated by solar power system 104 through utility meter 132 and onto a utility grid. The utility “buys” this excess power by crediting the user's utility account for the amount of power pushed onto the grid. For example, when power is pushed from solar power system 104 to the utility grid, utility meter 132 turns backwards, thereby crediting the user's utility account.

In some embodiments, solar power system 104 works in parallel with the electric utility grid. For example, when the sun is shining, solar power system 104 can push any extra electricity it generates onto the grid. At night, loads are drawn from the utility grid. In some embodiments, a system integrator sets up a net-metering relationship with the local utility, enabling users to sell excess power back to the utility during peak hours when rates are high, and to buy electricity during non-peak hours when the rates are low.

In some embodiments, solar power system 104 can be standardized or unique, configured to the custom specifications of each user and/or that user's home 116. For example, a system integrator visits user's home 116 to determine the best size, mounting arrangement and positioning for solar power system 104. A detailed design and installation plan can then be engineered.

In some embodiments, environment 100 includes gateway 136 and power service 140. Gateway 136 is normally located at house 116 and is communicatively coupled with components at house 116. For example, gateway 136 can be communicatively coupled with inverter 124 and utility meter 132. The gateway is also communicatively coupled with power service 140 via network 144, such as the Internet. It should be appreciated that gateway 136 can be a standalone device that is separate from the other components at house 116, or gateway 136 can be fully or partially embedded or integrated with one or more component at house 116. In some embodiments, power service 140 is or includes server computer 148 (or a cluster/farm of server computers) that is remote from user's house 116. Power service 140 may be operated by, e.g., the installer or service provider of solar power system 104, a utility company, or some other entity.

In some embodiments, gateway 136 and power service 140 carry out various tasks for monitoring the performance of solar power system 104. For example, gateway 136 can collect system operating statistics, such as the amount of PV energy produced (via PV inverter 124), the energy flow to and from the utility grid (via utility meter 132), and so on. Gateway 136 can then send this data to power service 140 via network 144 for logging and system performance analysis.

In some embodiments, power service 140 monitors the data to make sure solar power system 104 is producing solar energy at optimum levels. For example, data reports can be collected periodically about current/voltage/power coming from solar panels 120, outside temperatures at their respective locations, operating temperature of inverter 124, user electrical loads supplied by electrical panel 128, utility meter 132 readings, condition of the utility grid at that feedpoint, occupancy sensors, building temperature, etc. If solar power system 104 underperforms, alerts can be sent to call attention to the situation.

In some embodiments, collected data can be accessible online for customers or other approved entities to view. For example, solar power portal 152 can allow users to log in to a secure website to check the performance of solar power system 104, as reported to power service 140 by gateway 136. Users can find out how much power the system is generating at any time. It should be appreciated that although the examples provided herein involve solar power system, embodiments could also related to other renewable and non-renewable energy production systems.

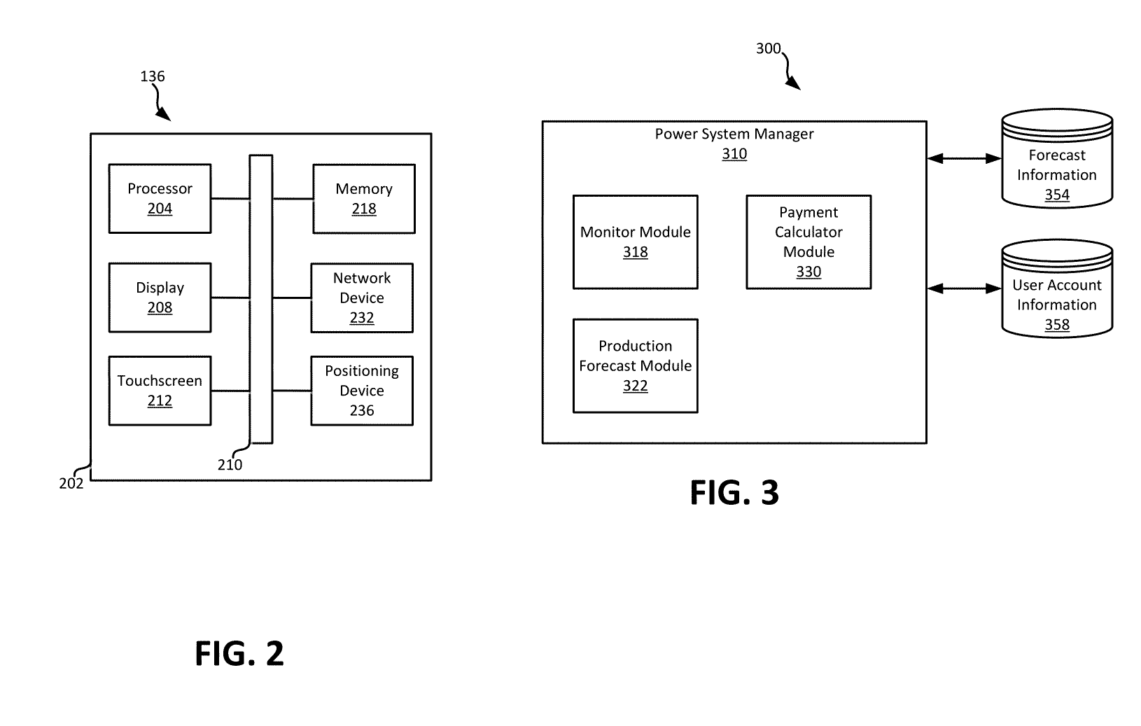

FIG. 2 shows a block diagram of example gateway 136 in accordance with various embodiments. For example, gateway 136 can be enclosed by external casing 202 that protects the interior components from being damaged. External casing 202 can be made of any suitable material such as plastic, metal, etc. Gateway 136 may include any number of tactile input controls, including switches, keys, buttons, touch sensitive buttons, etc. Gateway 136 can also include display 208, which may display various images generated by the gateway 136. Display 208 may be any type of display such as a light-emitting diode (LED) based display, a Retina display, a liquid-crystal display (LCD), etc. Gateway 136 may include touch screen 212 that a user can select elements of display 208 by touching the selected elements.

In some embodiments, display 208 may be used to display a graphical user interface (GUI) that allows a user to interact with gateway 136. The tactile input controls or touchscreen 212 may be used to navigate the GUI. Gateway 136 may include audio input and output elements, such as microphones that receive audio input and speakers that output sound.

In some embodiments, gateway 136 includes processor 204 that provides the processing capability required to execute an operating system, applications, and other functions of gateway 136. Processor 204 also may include onboard memory for caching purposes and may be connected to data bus 210 so that it can provide instructions to the other devices connected to data bus 210.

In some embodiments, gateway 136 may also include storage memory 218 for storing data required for the operation of processor 204 as well as other data required by gateway 136. For example, storage memory 218 may store the firmware for the gateway 136 usable by processor 204, such as an operating system, other programs that enable various functions of gateway 136, GUI functions, and/or processor functions. Storage memory 218 may also store data files such as software applications, etc.

In some embodiments, gateway 136 includes network device 232 for receiving and transmitting information over one or more communications channels. As such, network device 232 may include one or more network interface cards (NIC) or a network controller. In some embodiments, network device 232 may include a local area network (LAN) interface for connecting to a wired Ethernet-based network and/or a wireless LAN, such as an IEEE 802.11x wireless network (i.e., WiFi). In certain embodiments, the LAN interface may be used to receive information, such as the service set identifier (SSID), channel, and encryption key, used to connect to the LAN. In some embodiments, gateway 136 obtains information from the inverter 124 via the LAN interface. Network device 232 also may include a wide area network (WAN) interface that permits connection to network 144, such as Internet 144. Network device 232 may also include a personal area network (PAN) interface for connecting to a PAN such as a Bluetooth® network, an IEEE 802.15.4 (ZigBee) network, or an ultra wideband (UWB) network. Network device 232 may interact with an antenna to transmit and receive radio frequency signals. Network device 232 may include any number and combination of network interfaces.

In some embodiments, inverter 124 is equipped with or operatively coupled to a network device, such as LAN interface, either wireless or wired, and inverter 124 is capable of transmitting information to gateway 136 via a wireless or wired LAN of house 116. For example, inverter 124 can transmit, via the LAN, to gateway 136 information related to the actual AC power generated by solar system 104, and gateway 136 can transmit, via network 144, the information to power service 140.

In some embodiments, gateway 136 includes positioning device 236 to determine geographical position. Positioning device 236 may utilize the global positioning system (GPS) or a regional or site-wide positioning system that uses cell tower positioning technology or WiFi technology, for example.

Referring again to FIG. 1, network 144 may include any appropriate network, including an intranet, the Internet, a cellular network, a wireless local area network, a local area network, a wide area network, a wireless data network, or any other such network or combination thereof. Components utilized for such a system may depend at least in part upon the type of network and/or environment selected. Protocols and components for communicating via such a network are well known and will not be discussed herein in detail. Communication over the network may be enabled by wired or wireless connections and combinations thereof.

Power service 140 can include at least one server 148 and data store 150. It should be understood that there may be several servers (e.g., application servers, web servers, etc.), layers, or other elements, processes, or components, that may be chained or otherwise configured, and that may interact to perform tasks, such as obtaining data from an appropriate data store. As used herein the term “data store” refers to any device or combination of devices capable of storing, accessing, and/or retrieving data, which may include any combination and number of data servers, databases, data storage devices, and data storage media, in any standard, distributed, or clustered environment.

In some embodiments, server 148 is an application server that includes any appropriate hardware and software for integrating with data store 150 as needed to execute aspects of one or more applications. For example, server 148 can be an application server that provides solar-related services in cooperation with data store 150, and that is able to generate content such as text, graphics, audio, and/or video to be transferred to the user, which may be served to the user via power portal 152. The user may view said content using a native application on a client device by a web server in the form of HTML, XML, or another appropriate structured language.

Server 148 may include an operating system that provides executable program instructions for the general administration and operation of the server, and it may further include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

Power service 140 in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are shown in FIG. 1. Thus, the depiction of power service 140 in FIG. 1 should be taken as being illustrative in nature, and not limiting to the scope of the disclosure.

Power service 140 of FIG. 1 may include additional components and/or other arrangements, as shown in system 300 of FIG. 3. In this example, system 300 includes power system manager 310 that can communicate with gateway 136 to provide services related to solar power system 104. In some embodiments, power system manager 310 is an application executed on server 148.

In some embodiments, power system manager 310 includes monitor module 318, a production forecast module, and payment calculator module 330. Power system manager 310 can read and/or write data to forecast information data store 354 and user account data store 358. Data stores 354 and 358 may be implemented as part of power system manager 310 or separately from power system manager 310 depending on the embodiment.

In some embodiments, forecast information 354 includes, for example, information from multiple sources including solar equipment manufacturers, government agencies, weather stations, and solar power equipment a multiple installations, including solar power system 104 of house 116. In some embodiments, power production forecast module 322 can collect streams of information from these multiple sources, e.g., using an Internet webserver. For example, power production forecast module 322 can separate the data streams by user, and user identification is used to template such data streams onto models of the users' equipment configurations and topologies. It then sorts and groups user data by categories, e.g., on an anonymous user basis. A common denominator can be applied, like all user systems using a particular brand/model of inverter.

Is some embodiments, user account information 358 includes information specific to solar power systems, such as system 104, of particular users. For example, monitor module 318 collects performance information from the solar power systems of multiple users and assembles said information on a per account basis. This information can be used to access single-user statistics, monitor operational flags, initiate/display reports, and engage payables, receivables, and other accounting operations. Additionally, portions this information can be posted to the Internet on a webpage for the respective user, e.g., power portal 152. Each user can see how much power they are generating/using, and the net amount they are exporting/importing. Various kinds of charts and graphics can be rendered in HTML to make the data easy to navigate, absorb and understand.

In some embodiments, user account information 358 includes information related to purchase agreements of individual users. For example, such information include information related to principal, loan term, interest rate, value of the system, rebates and other tax information, and payment information such as equivalent kilowatt-hour (kWh) rates, history of payments, and whether the user has an interest balance.

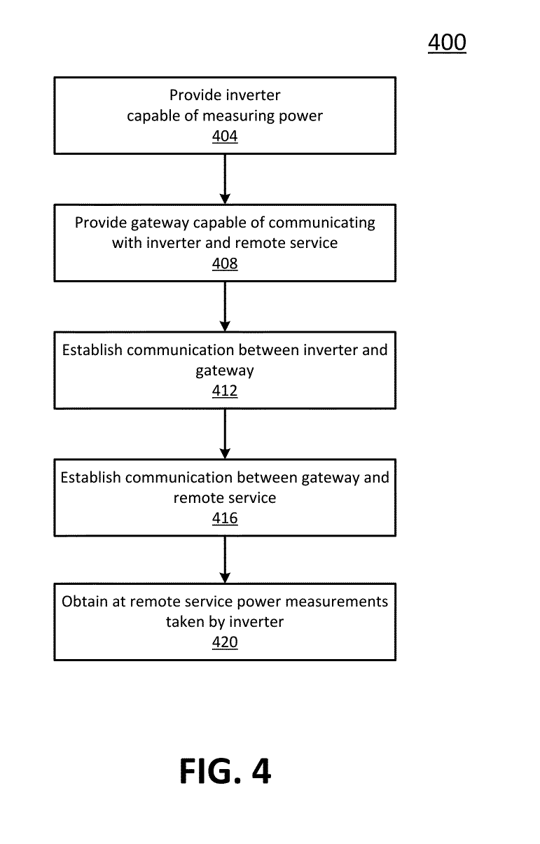

FIG. 4 shows example process 400 for measuring an amount of power generated by a renewable power system, according to an embodiment. Some or all of process 400 (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program comprising a plurality of instructions executable by one or more processors. The computer-readable storage medium may be non-transitory. The one or more computer systems may be, as an example, one or more computer systems in environment 100 of FIG. 1 that collectively implement power system manager 310 described above in connection with FIG. 3.

Process 400 generally begins, as indicated at block 404, by providing an inverter capable of measuring an amount of power generated by a renewable power system and communicating information related to the measured amounts. For example, inverter 124 may be provided for measuring power generated by solar power system 104. In some embodiments, inverter 124 measures the amount of AC power outputted by inverter 124. In some embodiments, inverter 124 measures the amount of DC power outputted by solar panels 120. At block 408, process 400 involves providing a gateway capable of communicating with the inverter provided at block 404 and with a remote service. For example, gateway 136 may be provided for communicating with inverter 124 and power service 140.

At block 412, communication is established between the inverter and the gateway. For example, communication may be established between inverter 124 and gateway 136. As noted above, inverter 124 and gateway 136 may be communicatively coupled via a wired and/or wireless connection. In some embodiments, inverter 124 and gateway 136 are separate components. In some embodiments, inverter 124 and gateway 136 are partially or completely integrated with each other. At block 416, communication is established between the gateway and the remote server. For example, communication may be established between gateway 136 and power service 140. In some embodiments, gateway 136 communicates with power service 140 via the Internet. At bock 420, the server obtains power measurements that were taken by the inverter. For example, inverter 124 transmits a power measurement to gateway 136, which transmits the power measurement to power service 140.

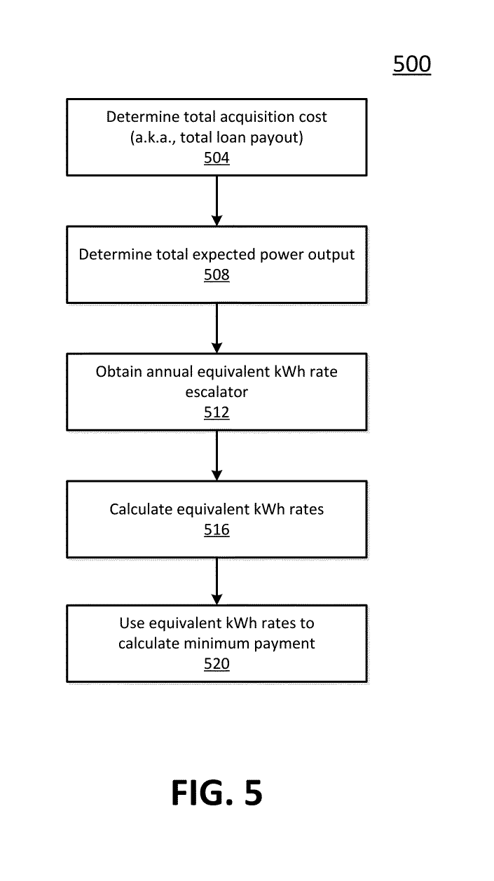

FIG. 5 shows example process 500 for valuating or assessing a value of power generated by a renewable power system based at least in part on an acquisition amount of the renewable power system, according to an embodiment.

Process 500 generally begins when a renewable power system is acquired. For example, process 500 begins when a user acquires solar power system 104. At block 504, process 500 involves determining a total acquisition amount or cost of the renewable power system. In some embodiments, a user finances solar power system 104 and the total acquisition amount generally corresponds to the total loan payout, which includes the total principal amount of the loan and the total interest that will be paid during the term of the loan.

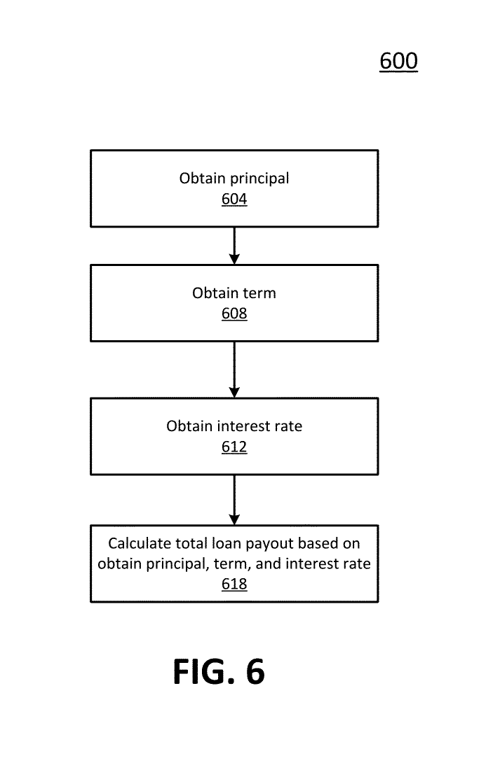

FIG. 6 shows example process 600 for determining the total acquisition amount of a renewable power system, such as solar power system 104. As shown, process 600 generally begins at block 604, where the principal amount of the loan is obtained. For example, payment calculator module 330 can obtain information that indicates the principal amount of the loan used to acquire solar power system 104. The principal amount can be equal to the purchase price and other initial costs, such as installation costs, of solar power system 104. At block 608, the term of the loan is obtained, and, at block 612, the interest rate of the loan is obtained. For example, in addition to obtaining the principal amount of the loan used to acquire solar power system 104, payment calculator module 330 can also obtain the term and interest rate of that loan. In some embodiments, a user can cause a reduction in the interest rate by engaging in activities that reduce lending risks. These rate-reduction activities include signing up for auto-draft such that payments are automatically drafted from the user's deposits account or automatically charged to the user's credit account.

At block 618, the total payment amount of the loan is determined based at least in part on the principal amount, the term, and the interest rate of the loan. For example, payment calculator module 330 determines the total payout amount of the loan by determining a monthly payment amount of the loan and multiplying that amount by the number of months included in the term of the loan. For example, the monthly payment can be determined using the following formula:

M=P[i(1+i)̂n]/[(1+i)̂n−1]

M=monthly payment
P=principal of loan
i=interest rate
n=number of months included in loan term.
Continuing with this example, the monthly payment amount is then multiplied by the total number of months included in the term of the loan. For example, the thirty-year loan term include 360 months (i.e., 12 months*30=360 months). In some embodiments, the expected useful life of the power system being acquired is greater than the term of the loan.

Referring again to FIG. 5, process 500 involves determining the total expected power output of a renewable power system, such as solar power system 104. In some embodiments, total expected power output represents the total amount of power that solar power system 104 is expected to output during the term of a loan used to finance the acquisition of solar power system 104. For example, if the term of the loan were thirty years, then the total amount of expected power output would be the total amount of power outputted over thirty years.

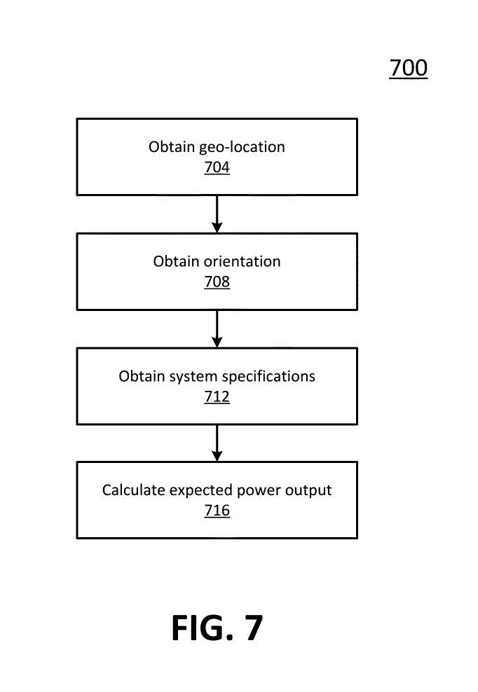

FIG. 7 shows example process 700 for determining a total amount of expected power to be generated by a renewable power system, such as solar power system 104. In some embodiments, power production forecast module 322 of power system manager 310 implements process 700. As shown, process 700 generally begins at block 604, where the geo-location of a renewable power system is obtained. For example, this involves obtaining geo-location information related to a site where solar power system 104 is installed. As shown in FIG. 1, solar power system 104 is installed at house 116. In this case, the geo-location of solar power system 104 may be obtained by reverse geo-coding the address of house 116. It should be appreciated that the geo-location can be obtained in many different ways known to those having skill in the art. For example, solar panels 120, gateway 136 and/or inverter 124 may include components for determining and transmitting geo-location to power system manager 310 via network 144. Also, for example, the user may input location information via power portal 152.

Referring again to FIG. 5, process 500 involves obtaining an annual equivalent kWh rate escalator, as indicated at block 512. In some embodiments, the annual equivalent kWh rate escalator accounts for the starting equivalent kWh rate, the depreciating production of the solar power system, the increase in the interest rollover, and the natural escalation of principal payments to allow for the loan to fully amortize within the loan term. In some embodiments, the starting equivalent kWh rate is positioned at or below the prevailing electricity rates provided by the local utility. In some embodiments, the annual equivalent kWh rate escalator remains fixed during the term of the loan. In some embodiment, a loan is used to finance acquisition of a renewable power system. In these embodiments, the loan repayment is structured so that it mimics a typical utility payment. For example, a user is charged for an amount of power generated by a renewable power system, but the proceeds of the user's payment are applied to pay the interest and/or principal of the loan. This repayment structure provides users with the added benefit of avoiding fluctuating kWh rate increases that are typical with local utility kWh rates. In some examples, the annual equivalent kWh rate escalator can be negotiated between the parties, can be obtained from a standard setting body, such as an industry or government organization, or can be obtained for any other source, etc.

As indicated at block 516, process 500 involves calculating equivalent kWh rates. In some embodiments, equivalent kWh rates are used to structure a loan repayment that mimics a typical utility payment, thereby giving users flexibility to make loan payments like they are paying for electricity. In some embodiments, equivalent kWh rates are based at least in part on a ratio of the total loan payout (see block 504) to the total expected power output (see block 508), where the ratio is adjusted by the annual equivalent kWh rate escalator (see block 512) to account for the increasing cost of renewable power over the term of the loan.

As indicated at block 520, process 500 can involve using the equivalent kWh rates to automatically calculate an actual payment amount for the power produced by the solar power system. In some embodiments, this payment amount is in lieu of a traditional loan repayment, which amortizes the loan and is based solely on principal and interest payments. In some embodiments, the actual payment amount for a period (e.g., month, year, etc.) is equal to the product of the equivalent kWh rate for that period and the actual amount of power produced by solar power system 104 during that period. As discussed, in some embodiments, the actual power produced by solar power system 104 is measured by inverter 124, and transmitted from gateway 136 to power service 140.

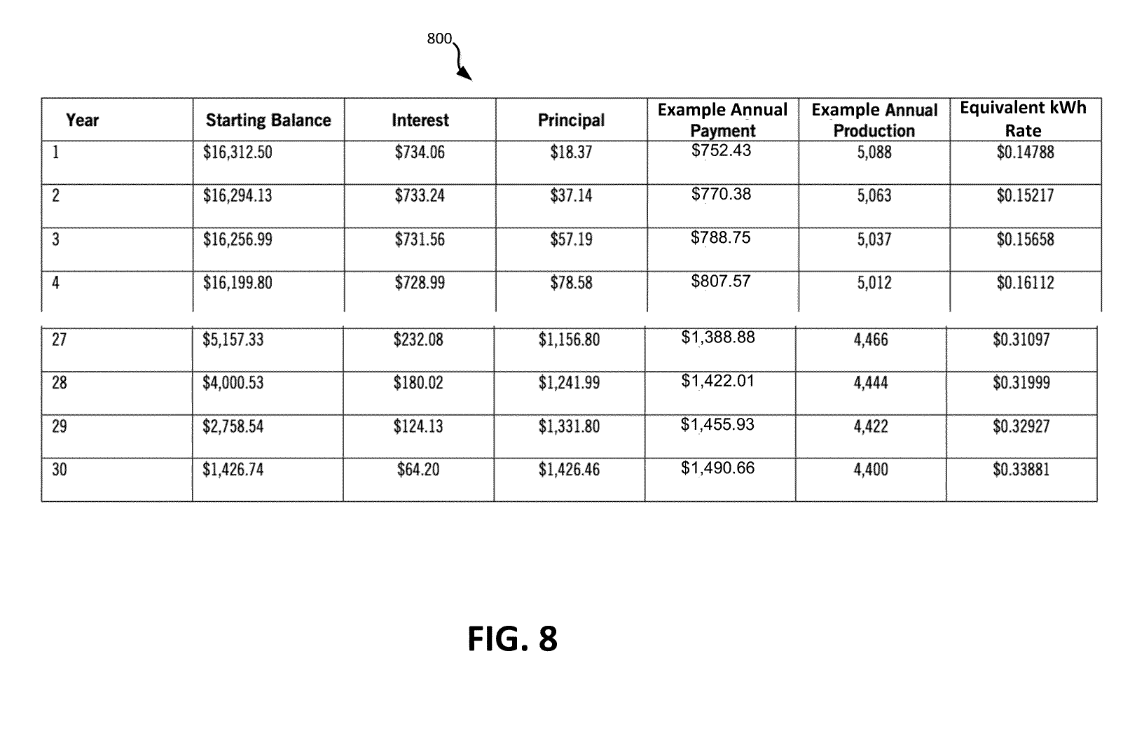

FIG. 8 shows example valuation table 800 that lists annual payment amounts, along with corresponding annual power production amounts and loan repayment rates (e.g., equivalent kWh rates). In some embodiments, the annual payment amount (interest plus principal) for a year is equal to the product of the loan repayment rate (e.g., equivalent kWh rate) and the annual power production amount for that year. In some embodiments, the annual power production amount varies from year to year, thereby causing the annual payment amount to vary by a corresponding amount. A simplified example will now be provided with reference to table 800 for purposes of illustrating the step (block 520) of calculating an actual payment amount for the power produced by the solar power system. As shown in the row of table 800 that corresponds to year 1, the loan repayment rate is $0.14788/kWh and the annual power production amount is 5,088 kWh. In this illustrative example, the annual payment amount for year 1 is ($0.14788/kWh)×(5,088 kWh)=$752.43. It should be appreciated that table 800 is provided for illustrative purposes and that repayment calculations may account for other factors. For example, table 800 does not account for periods in which a renewable power system fails to produce an amount of power equal in value to interest owed during those periods. Further, it should be appreciated that table 800 shows annual payment and production periods for illustrative purposes, and that other periods (e.g., semiannual, monthly, weekly, and/or daily) may be used.

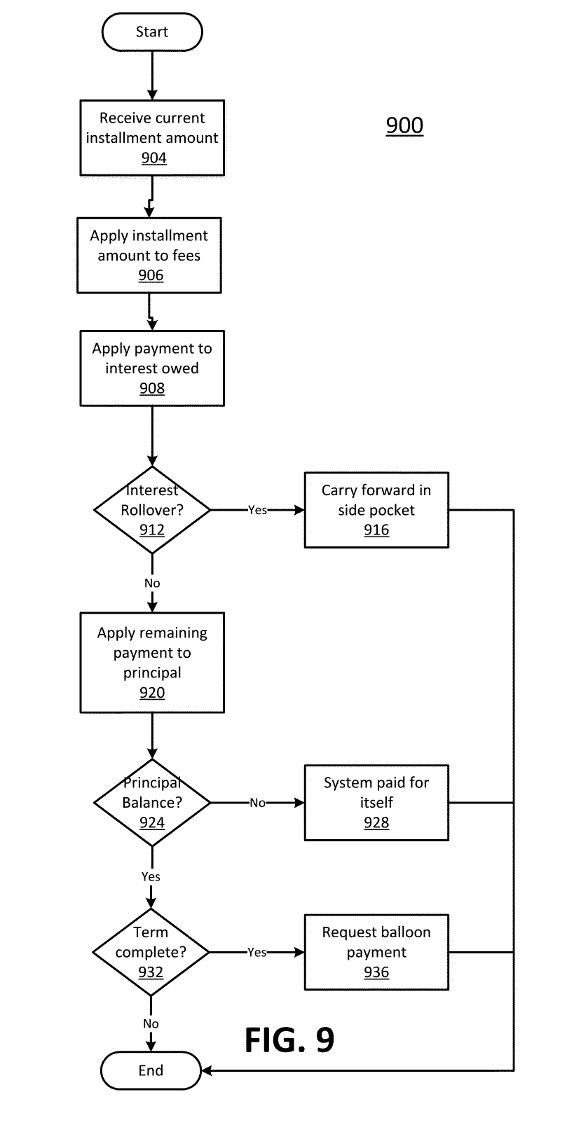

FIG. 9 shows example process 900 of processing an installment amount paid toward the costs of acquiring a renewable power system, according to an embodiment. As indicated at block 904, process 900 can begin when receiving a current installment amount. In some embodiments, the current installment amount is a current payment owed on a loan used to acquire a renewable power system, even though the installment amount is based on power generated by the renewable power system during the relevant period. At bock 906, process 900 involves applying the installment amount to any outstanding fees owed on the loan. At bock 908, process 900 involves applying the remaining portion of the installment amount to any interest owed on the loan.

In some embodiments, a weather accommodator feature is provided for accounting for fluctuating and seasonal weather patterns. For example, in the event the power system is a solar power system, the weather accommodator feature accounts for shorter days and cloudy weather. An example embodiment of the weather accommodator feature can be described with reference to blocks 908, 912, and 916, for example.

Referring again to block 908, in addition to interest accrued during the relevant period, interest owed can also include Interest Rollover, which is interest that accrued during a previous period(s) when the relevant renewable power system failed to generate an amount of power having a value equal to or greater than the interest that accrued during that period(s). In these embodiments, at block 908, the installment amount is applied to any Interest Rollover and then to the interest accrued during the latest period. At decision block 912, process 900 determines whether any Interest Rollover remains after application of the installment amount to interest owed. For example, if the installment amount was less than the interest owed (including Interest Rollover from previous periods), then Interest Rollover remains. At block 916, any remaining Interest Rollover is placed in a side pocket and carried forward to the next period. In some embodiments, Interest Rollover is not added to the principal amount, thereby preventing negative amortization.

On the other hand, if there is no Interest Rollover and a portion of the installment amount is leftover, process 900 involves applying the leftover installment amount to the principal, as indicated at block 920. At decision block 924, process 900 determines whether any principal balance remains after the installment amount is applied to the principal. At block 928, if no balance remains, then process 900 determines that the relevant renewable power system has been paid for. Referring again to decision block 924, if a principal balance still remains, then process 900 determines whether the term of the loan is complete, at indicated at decision block 932. For example, in embodiments where a loan is used to acquire a renewable power system, if the loan is for a term of thirty years (360 months) and the current installment is the last payment of the thirty-year term, then process 900 involves requesting a balloon payment for the remaining principal balance still owed on the loan, as indicated at block 936. If, however, the term is not complete, process 900 ends.

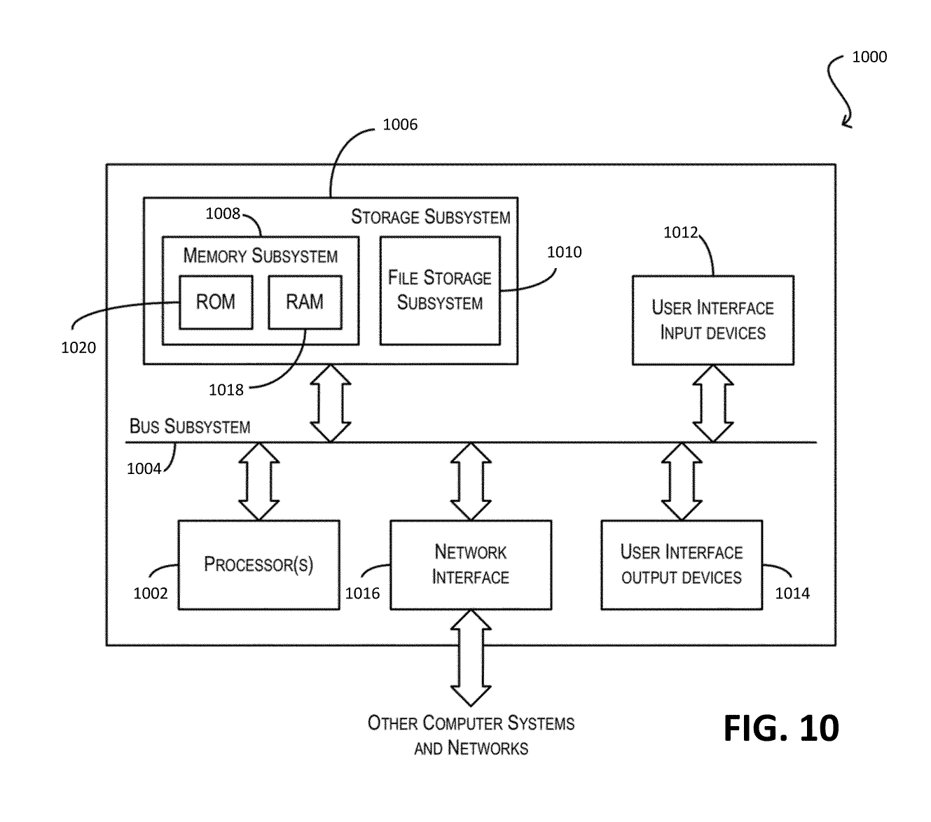

FIG. 10 shows a simplified block diagram of example computer system 1000. Computer system 1000 can be used to implement any of the computer systems/devices described with respect to FIG. 1. As shown in FIG. 10, computer system 1000 can include one or more processors 1002 that communicate with a number of peripheral devices via bus subsystem 1004. These peripheral devices can include storage subsystem 1006 (comprising memory subsystem 1008 and file storage subsystem 1010), user interface input devices 1012, user interface output devices 1014, and network interface subsystem 1016.

Bus subsystem 1004 can provide a mechanism for letting the various components and subsystems of computer system 1000 communicate with each other as intended. Although bus subsystem 1004 is shown schematically as a single bus, alternative embodiments of the bus subsystem can utilize multiple buses. Network interface subsystem 1016 can serve as an interface for communicating data between computer system 1000 and other computer systems or networks. Embodiments of network interface subsystem 1016 can include wired interfaces (e.g., Ethernet, CAN, RS232, RS485, etc.) or wireless interfaces (e.g., ZigBee, Wi-Fi, cellular, etc.).

User interface input devices 1012 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and/or any other type of input device. In general, use of the term “input device” is intended to include all possible types of devices and mechanisms for inputting information into computer system 1000. User interface output devices 1014 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 1000.

Storage subsystem 1006 can include memory subsystem 1008 and file/disk storage subsystem 1010. Subsystems 1008 and 1010 represent non-transitory computer-readable storage media that can store program code and/or data that provide the functionality of embodiments of the present invention. Memory subsystem 1008 can include a number of memories including main random access memory (RAM) 1018 for storage of instructions and data during program execution and read-only memory (ROM) 1020 in which fixed instructions are stored. File storage subsystem 1010 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1000 is illustrative and not intended to limit embodiments of the present invention. Many other configurations having more or fewer components than system 1000 are possible.

What is claimed is:

1. A solar power system, comprising:
a photovoltaic solar panel configured to generate direct current (DC)-based power (DC power);
an inverter coupled to the photovoltaic solar panel for converting the DC power into alternating current (AC)-based power (AC power);
a power meter coupled to the inverter for measuring an amount of actual AC power generated by the solar power system;
a gateway communicatively coupled to the power meter for receiving power data corresponding to the measured actual amount of AC power generated by the solar power system; and
a server communicatively coupled to the gateway and configured to:
receive, from the gateway, the power data corresponding to the measured actual amount of AC power generated by the solar power system;
assess a value of the measured actual amount of AC power generated by the solar power system based at least in part on the product of an equivalent power rate and the measured actual amount of AC power generated by the solar power system; and
calculate a payment amount based at least in part on the value of the measured actual amount of AC power generated by the solar power system and a total acquisition amount of at least a portion of the solar power system.

2. The system of claim 1, wherein the equivalent power rate is based at least in part on a total expected power output of the solar power system and the total acquisition amount.

3. The system of claim 2, wherein the total expected power output of the solar power system is determined based at least in part on a location, a rating of the solar panel, a rating of the inverter, shading information, and tilt information.

4. The system of claim 1, wherein the photovoltaic solar panel, the inverter, the power meter, and the gateway are installed at a home of a user.

5. The system of claim 1, wherein the payment amount is an installment payment amount based at least in part on the total acquisition amount.

6. The system of claim 1, wherein the payment amount is an installment payment amount based at least in part on an acquisition period, wherein the acquisition period is a plurality of months and the installment payment amount is for one of the plurality of months within the acquisition period.

7. A method, comprising:
monitoring, by a server, an amount of actual power generated by a power system by obtaining power data from a gateway that is communicatively coupled to a power measuring component of the power system, wherein the power data corresponds to the amount of actual power generated by the power system;
obtaining, by the server, an equivalent power rate for power generated by the power system, wherein the equivalent power rate is based at least in part on a total acquisition amount of a least a portion of the power system and a total expected power output of the power system;
assessing, by the server, a value of the amount of actual power generated by the power system based at least in part on the product of the equivalent power rate and the amount of actual power generated by the power system; and
calculating, by the server, an installment amount based at least in part on the value of the amount of actual power generated by the power system, the total acquisition amount of the power system, and an acquisition period.

8. The method of claim 7, wherein the acquisition period is a plurality of months and the installment payment amount is for one of the plurality of months within the acquisition period.

9. The method of claim 7, wherein the power system is a solar power system that includes a solar panel, wherein the power measuring component is an inverter, wherein the inverter is configured to convert power generated by the solar panel from DC power to AC power.

10. The method of claim 9, wherein the inverter is further configured to measure the actual amount of power produced by the power system.

11. The method of claim 9, wherein the total expected power output of the power system is determined based at least in part on a location, a rating of the solar panel, a rating of the inverter, shading information, and tilt information.

12. The method of claim 7, wherein the gateway and the power system are installed at a home of the user and the gateway transmits to the server information related to the power generation of the power system.

13. The method of claim 7, further comprising:
increasing the equivalent power rate during the acquisition period to account for depreciating production of the power system.

14. The method of claim 7, wherein an expected useful life of the power system is greater than the acquisition period.

15. The method of claim 7, where the power system is a solar power system, a wind power system, a fossil-fuel based power system, a hydropower system, a nuclear power system, a biofuel power system, or a battery power system.

16. A method, comprising:
monitoring, by a server, an amount of actual power generated by a solar power system by obtaining power data from a gateway that is communicatively coupled to a power measuring component of the solar power system, wherein the power data corresponds to the amount of actual power generated by the solar power system;
obtaining, by the server, an equivalent kWh rate for power generated by the solar power system, wherein the equivalent kWh rate is based at least in part on a total acquisition amount of at least a portion of the solar power system and a total expected power output of the solar power system, wherein the total expected power output of the solar power system is the total expected power output during a term of a loan;
assessing, by the server, a value of the amount of actual power generated by the solar power system based at least in part on the product of the equivalent kWh rate and the amount of actual power generated by the solar power system; and
calculating, by the server, a payment amount based on the value of the amount of actual power generated by the solar power system and the total acquisition amount.

17. The method of claim 16, wherein the total expected power output of the solar power system is determined based at least in part on a location, a rating of the solar panel, a rating of the inverter, shading information, and tilt information.

18. The method of claim 16, wherein the gateway and the solar power system are installed at a home of a user and the gateway transmits to the server information related to the power generation of the power system.

19. The system of claim 18, the payment amount is an installment payment amount relating to acquisition by the user of the solar power system.

20. The system of claim 19, wherein the installment payment amount is based at least in part on an acquisition period, wherein the acquisition period is a plurality of months and the installment payment amount is for one of the plurality of months within the acquisition period.
